(19) United States
(12) Patent Application Publication
(10) Pub. No.: US 2024/0037771 A1
(43) Pub. Date: Feb. 1, 2024

(54) A METHOD AND A SYSTEM FOR DETERMINING A WEIGHT ESTIMATE OF A FOOD ITEM

(71) Applicant: MAREL SALMON A/S, Stovring (DK)

(72) Inventors: Anders KJAER, Stovring (DK); Martin ANDERSEN, Stovring (DK)

(21) Appl. No.: 18/256,087

(22) PCT Filed: Dec. 17, 2022
(86) PCT No.: PCT/EP2021/086605

§ 371 Date: Jun. 6, 2023

(30) Foreign Application Priority Data
Dec. 17, 2020 (EP) 20215045.4

(51) Int. Cl. G06T 7/62; A22C 25/04

(52) U.S. Cl. CPC G06T 7/62; A22C 25/04; G06T 2207/30128; G06T 2207/20021

(57) ABSTRACT

A method and a system for determining a weight estimate of food items include receiving an image of an outer surface of a food item. The image having a plurality of pixels each having a measure. By the measure of the pixels, a surface content of a first tissue which is distinct from a second tissue is identified. The surface content is translated into a volume content and a density parameter is recorded. An estimate of the weight is determined based on the volume content, the density parameter, and volume data identifying the volume of the food item.

### INTRODUCTION

The present disclosure relates to a method and a system for determining a weight estimate of a food item.

### BACKGROUND

For processing food items, the weight of the food item is often a useful parameter. However, since food items can contain different constituents, such as different tissues, and can be of different size and shape, processing can be cumbersome as each food item has to be weighed individual.

A traditional measure is useful for weighing a food item, but evaluation of the weight of a possible portion of the food item may be desirable, e.g. for portioning purposes. When preparing number of portions to cut from a food item it may be considered sufficient to weigh the food item and divide the weight with the volume to obtain a density, and use this for estimation of portion weights, however, to obtain correct portion weights that requires a homogeneous density throughout the entire food item, it requires each food item to be weighed by a measure, which process can be time consuming and/or require space and further equipment in the processing line.

Cameras are frequently used to identify different organs, sizes and shapes, or other features of food items.

### SUMMARY

To improve the ability of processing food items, the present disclosure in a first aspect provides a method of determining a weight estimate of food items, the method comprising the steps of:
a) receiving an image of an outer surface of a food item, the image comprising a plurality of pixels each having a measure;
b) identifying by the measure of the pixels, a surface content of a first tissue which, on the outer surface, is distinct from a second tissue;
c) translating the surface content into a volume content of the first tissue relative to the second tissue;
d) recording a density parameter of the food item, the density parameter comprising at least a first density contribution, e.g. one or more specific values of densities of the first tissue and a second density contribution e.g. one or more specific values of densities of the second tissue;
e) receiving food item volume data representing a volume of the food item or at least a section thereof; and
f) determining based on the volume content, the density parameter, and the food item volume data, a weight estimate of the food item or a section thereof.

The method may enable automatic weight estimation without the use of a scale and may thus improve speed and reduce complexity of food processing systems. Potentially, it may reduce labour requirements.

The method also takes into consideration different tissues of the food item, different densities of the tissues as well as variations of tissue densities. Accordingly, the weight can be determined individually for different parts of a food item even before the food item is cut into pieces. This provides an improved basis for portioning the food items into pieces having a desired weight.

Additionally, a scale may not be completely clean, and contaminants on the scale may reduce precision. Additionally, a scale typically requires the food items to be completely separated, such that only one food item is on the scale at a time. This limits the throughput on a conveyor belt and necessitates that the food items are located in a row, with no food items being side-by-side on the conveyor belt. According to the present disclosure, the weight of such side-by-side food items can be estimated as long as they can be distinguished from each other in the image.

The food item could e.g. be an item from the list consisting of vegetables, fruits, meat, poultry, fish, and seafood, or the food item could be a piece of such a vegetable, fruit, meat, poultry, fish, and seafood. Particularly, the method may be used in handling fish, such as fillets of fish, or meat, such as fillets of beef, pork, poultry, or slices thereof.

Tacky or sticky food items may have an increased tendency of sticking to a surface, and it may be a particular advantage to avoid movement of the food items onto a surface of a scale. The same applies to food items having a fragile or incoherent structure. Accordingly, the method has a particular advantage for estimating weight of such food items.

In one embodiment, the food item is a mammal, a fish, or a part thereof. Specifically, the food item may be a fillet of a Salmonidae, such as a fillet of a salmon, or a trout. It may also be a fillet of e.g. a char, a grayling, a halibut, a Greenland halibut or a fillet of a whitefish. Preferably the food item is a non-heated food item i.e. the food item is not cooked, smoked, grilled or in other ways subjected to a heating process. The food item may also be smoked fillets such as smoked fish fillets.

In the context of the present disclosure, the term ‘fish fillet’ should be understood as a part of a fish where the fish has been cut or sliced away from the bone by cutting lengthwise along one side of the fish parallel to the backbone. The skin present on one side may or may not be stripped from the fillet. In an alternative embodiment, the food items may be fish steaks (also known as fish cutlets). The fish steaks contrast with the fish fillets cut perpendicular to the spine. In fillets, or steaks e.g. of fish, the method may be particularly suitable, since the internal tissue, particularly fat and meat, becomes clearly visible.

The image may, as an example, be a colour image or a monochrome image which may be captured with image capturing means known in the art, including cameras capturing electromagnetic radiation, e.g. line or matrix type CCD cameras or any similar kind of camera, including cameras capturing electromagnetic radiation outside the visible range, e.g. x-ray cameras. As a further alternative, ultrasound may be used.

The image is represented by image data including the location of each pixel and for each pixel, the measure of the pixel.

When used herein, the measure of the pixel may include e.g. an intensity, a brightness and/or a chromaticity of the pixel.

“Image data” may be understood as data (such as spatially resolved in two or three dimensions) representative of brightness and/or chromaticity, such as observed by a measuring device, such as a scanner (e.g., scanning a point in raster pattern or scanning multiple lines) or an optical camera (e.g., obtaining the image data in a single snapshot). The image data may be monochromatic or colour, such as comprising information on red, green and blue (RGB) intensities. By ‘optical’ is understood that the image data is obtained via electromagnetic radiation having wavelengths within the interval [100 nm; 1 mm], such as corresponding to ultraviolet radiation (UV), the spectrum of light visible for man (VIS) and infrared radiation (IR). In a particular embodiment, the image data is obtained for electromagnetic radiation within the interval [380 nm; 740 nm], such as corresponding to the spectrum of light visible for man (VIS).

“Data” may generally be understood to be digital data.

The image visualises distinct tissues on the outer surface of the food item, and the distinct tissues are identified. The distinct tissue may include e.g. meat, fat, bones, cartilages, etc. and the measure is used for distinguishing a first distinct tissue from a second distinct tissue.

Fat may, as an example reflect light different from meat and therefore be identifiable by an intensity or brightness of the pixel, or fat may have a different colour and be identifiable by a chromaticity of the pixel. The identification process provides a surface content of the first tissue distinct from the second tissue. The method may e.g. comprise a step of comparing the colour of each pixel in the image with a threshold value. As an example, where the first tissue is meat, the colour may be compared to a measure of red, and if the colour of the first tissue is higher than a predetermined threshold value on the measure, the pixel may be categorised as meat. If the colour of the first tissue is lower than a predetermined threshold value on the measure, the pixel may be categorised as fat. Other processes may also be used to determine whether the part of the food item belongs to the first tissue or to the second tissue.

“Identifying by the measure of the pixels, a surface content of a first tissue which is distinct from a second tissue”, is meant that:
an absolute surface area of the first tissue and second tissue is determined, a ratio of the area of the first tissue relative to the second tissue is determined, this is herein referred to as an image ratio, and/or
each pixel or a group of pixels is assigned to one of the first and second tissues meaning that the identification step identifies where in the image the first tissue is found and where in the image the second tissue is found.

The method comprises the step of translating the surface content into a volume content of the first tissue relative to the second tissue. By the step of translation, the content of e.g. fat on the surface is translated into a content throughout the food item.

“Volume content”, is herein meant:
an absolute amount of the first tissue and second tissue, i.e. not only in the surface but throughout the food item, and/or
a ratio of the first tissue relative to the second tissue throughout the food item, this is herein referred to as a food item ratio.

The translation may be carried out by a model, herein referred to as a transfer function. The transfer function could be a mathematic model expressing the volume content based on the surface content.

The translation may, as an example, be based not only on the image but additionally on empirical data. Herein, this is defined as data obtained e.g. by research and/or information regarding raising of the animal or plant and/or information related to handling or processing of the animal or plant.

The empirical data includes data relating to different aspects being decisive for the translation from surface content to volume content. Examples of such data could be a quantified metric, e.g. a height and/or width and/or a length of the food item. The volume amount of e.g. meat or fat may e.g. be higher if the height of the food item is in a certain range etc. Examples of empirical data are provided later.

The method further comprises a step of recording a density parameter of the food item, where the density parameter comprises at least a first density contribution related to the first tissue and a second density contribution related to the second tissue.

A density parameter for the food item thereby defines a density of each of the first and second tissues.

In embodiments, where further tissues are identified, the density parameter may comprise further density contributions.

In embodiments, where the first tissue is meat, and the second tissue is fat, the first density contribution may be the density of meat e.g. 1.05 g/cm³, whereas the second density contribution may be the density of fat e.g. 0.94 g/cm³.

The density parameter may also define different densities for the first tissue and/or different densities for the second tissue. This could be relevant e.g. since the same tissue may have different densities depending on different aspects, e.g. depending on the location of the tissue in the food item. Fat, taken as an example, may e.g. have different densities depending on whether it derives from a tail part or an abdomen part of a fish.

The method further comprises a step of receiving food item volume data representing a volume of the food item. In embodiments, where the food items are of substantially the same size, the food item volume data may be a fixed value associated with the food items. An example could be that all fish is considered to have a volume of e.g. 1000 cubic centimetre.

In embodiments, where the food items are of different size, the food item volume data may be determined in different ways. In one embodiment, simple means are used for measuring a thickness of the food item, e.g. a pivotable pin which is raised when the food items traverse below the pin. In this embodiment, the volume could be calculated e.g. by considering the food items always to have a fixed contour and a fixed ratio can be defined between the thickness and the volume:

V(h)=k*h

where V(h) is the volume for the height h, and k is a constant.

In another example, the volume could be determined e.g. by extracting a specific contour e.g. on the basis of the image. This may be converted to an area, and used, e.g. in the formula:

V(h,a)=k*a*h

where V(h, a) is the volume for the height h, and area a, and k is a constant.

If the image is a 2D image, it could still be used for determining the volume data, particularly if the height of the food item is substantially even.

In another embodiment, it may be necessary to assess the volume for substantially each food item individually. In such embodiments, the volume data may as an example be based on a 3D profile, e.g. an image of the food item taken with a 3D camera by use of equipment known in the art for establishing a 3D profile based on a 3D capturing of the food item.

The weight estimate of the food item is subsequently determined based on the food item ratio, the density parameter, and the food item volume data.

The weight estimate is not necessarily an exact weight, i.e. weight estimate is an approximate weight determined from the volume content, the density parameter, and the food item volume data.

“Three-dimensional profile data’ may be understood as any type of data (such as spatially resolved in two or three dimensions) comprising information about the three-dimensional profile of the surface of the food item, where ‘three-dimensional profile’ is to be understood as the shape of the surface (such as the three-dimensional locations of the parts of the surface) of the food item. The three-dimensional profile data may be chosen from the following non-limiting set of examples comprising a three-dimensional point cloud, a (rasterized) height map and one or more mathematical functions describing the surface shape, such z=ƒ(x,y), where distance z from a supporting surface is given as a mathematical function ƒ of lateral position (x, y).

The food item may comprise also a third tissue, a fourth tissue, a fifth tissue, etc., and it may be possible to determine further surface contents of such further distinct tissues.

The method steps a)-f) may be carried out in another order, as the numbering from a) to f) does not imply a specific sequence of steps. As an example, the step of recording a density parameter and/or the step of receiving food item volume data may be carried out before the step of receiving image and or the step of determining a surface content or translating the surface content into a volume content.

The estimation of the weight of the food item may be carried out before, after, or between other handling processes for the food item, such as sorting, cutting, slicing, trimming, pin-bone removing, batching, packing, or simply counting or registering the food item.

The translation of the surface content into the volume content may be carried out by linking each pixel or a group of pixels to a height of the food item at the pixel or at the group of pixels. Based on the height, the identified surface content can be converted into a volume content contribution, and the volume content may subsequently be determined by accumulation of the volume content contribution from each pixel or group of pixels.

As the height of the food item may vary along a length of the food item, an average height may be used as basis for the determination. Alternatively, the height of the food items may be determined at a plurality of locations, e.g. at each pixel or a defined group of pixels.

The method may comprise a step of extracting from a 3D profile of the food item, the height of the food item at each pixel or group of pixels in the image.

The method may further comprise extracting from a 3D profile of the food item, the food item volume data.

Step c) of translating the surface content into a volume content of the first tissue relative to the second tissue may, as mentioned previously, be carried out by use of a transfer function depending on the image and additionally depending on empirical data. Such empirical data may relate to, and define:
A season of the year, referred to hereon as “seasonal data”;
A characteristic of the food item, referred herein as “food data”, e.g. related to general conditions of the food item, in case of vegetables, it could relate to water content, in case of meat or fish, it could relate to the age of the animal, or other characteristics e.g. related to sexual maturity etc; and/or
A characteristic of the way the food item has been or is intended to be processed, herein referred to as “processing data”, e.g. related to the maturation of meat, or trimming and carving principles etc.

The empirical data may be found by testing. As an example, testing may show that one model may translate from surface content to volume content in a winter season, whereas another model, or other settings of the model may translate better in a summer season.

Accordingly, step c) of translating the surface content into a volume content of the first tissue relative to the second tissue may thus be carried out by use of a transfer function depending on seasonal data, food data, or processing data.

Two different ways may be implemented. In one group of embodiments, one transfer function uses empirical data and the image for the translation from surface content to volume content. In another group of embodiments, different transfer functions are selected based on the empirical data.

The method may e.g.:
select between one transfer function suitable for one type of food item and another transfer function for another type of food item, e.g. for two different species of fish etc.; or
select between one transfer function suitable for one season and another transfer function for another season, e.g. for summer or winter etc., or
select between one transfer function suitable for one previous or subsequent processing of the food item and another transfer function for another previous or subsequent processing of the food item, e.g. one for short term maturation of meat and another for long term maturation of meat.

The food items could particularly be moved by use of a conveyor system, such as conveyor belts, and the food items may be received in a continuous flow of food items.

As mentioned above, the food item volume data may be based on a 3D profile, e.g. obtained from an image of the food item. In one embodiment, the 3D image and the image of distinct tissues may be provided by a single image capturing device which may be capable of providing both the 3D image and the image.

The image capturing device may be in communication with a processing device which may convert the information from the 3D image into volume data. The processing device may also carry out the translation from surface content to volume content.

The method may further comprise a step of weighing the food item to determine an actual weight, a step of comparing the weight estimate and the actual weight obtained.

The method may further comprise amending the translation in step c, and/or amending the density parameter recorded in step d), where the amendment(s) depend on a deviation between the weight estimate found in step f) and the actual weight found by weighing the food item.

Consequently, it may be possible to calibrate the method e.g. to a plurality of food items, such as a batch of food items being different from a previous batch of food items. In one embodiment, the determination of the image ratio may be changed by amending the predetermined threshold value on a colour measure which is used to determine whether the pixel represents a first tissue or represents a second tissue or further tissues.

As an example, if it previously has been found that if the image ratio is 2% then the food item ratio is 3%, this may be changed so that an image ratio of 2% results in a food item ratio of 3.5%.

The method may further comprise a step of sectionalising the food item into a plurality of sections, and a step of determining a sectional weight estimate of the food item, where the sectional weight estimate is an estimate of the weight of the sections of the food item. Based on the food item ratio, the density parameter, and the food volume parameter, the food item may be divided into a plurality of sections. The sectionalisation may be carried out, so that sectional weight estimate is substantially the same for each of the sections.

The sectionalisation may be carried out as a pre-step prior to a step of cutting the food item into food portions, as the method may further comprise a step of cutting the food item into food portions, where the food portions are determined based on the sectional weight estimate.

In a second aspect, the disclosure provides a system for processing a food item, the system comprising:
at least one conveyor configured to move the food item in a flow of food items from a start position to at least one processing position;
an image capturing device configured to provide an image of the food item, the image comprising a plurality of pixels each having a measure;
a processing structure configured to:
   identify by the measure of the pixels, a surface content of a first tissue which is distinct from a second tissue;
   translate the surface content into a volume content;
   record a density parameter of the food item, the density parameter comprising at least a first density contribution related to the first tissue and a second density contribution related to the second tissue;
   receive food item volume data representing a volume of the food item; and
   determine based on the volume content, the density parameter, and the food item volume data, a weight estimate of the food item.

The processing structure may be constituted by a computer operatively connected to a storage device comprising a computer program with instructions which, when the program is executed by the computer, cause the computer to carry out the method according to the first aspect.

The system may comprise a 3D image providing device configured to provide a 3D profile of the food item, and wherein the processing structure is configured to extract from the 3D profile, the food item volume data and/or a height of the food item.

The system may form part of a batching or grading device comprising multiple receiving bins and a controller configured for assigning food items to the bins based on a batching or grading criteria comprising the weight of the food item, wherein the controller is configured to use the weight estimate determined based on the volume content, the density parameter, and the food item volume data for the assigning of the food items into the bins.

The controller may be configured to receive from a scale, a compiled weight of a plurality of food item contained in one of the bins, and to compare the compiled weight with summation of the estimated weight of each of the items in the bin. The controller may subsequently amend either the way the surface content is translated to a volume content, or the density parameter to minimize deviation between the estimated weight and the weight determined by a scale.

The controller may be configured to receive from a scale, a plurality of compiled weight of food items contained in a plurality of the bins, and to compare the compiled weight with summation of the estimated weight of each of the items in the bin.

A skilled person would readily recognise that any feature described in combination with the first aspect of the disclosure could also be combined with the second aspect of the disclosure, and vice versa.

The system according to the second aspect of the invention is very suitable for performing the method steps according to the first aspect of the invention. The remarks set forth above in relation to the method are therefore equally applicable in relation to the system.

The system may particularly comprise a conveyor structure allowing a gap to be formed between an infeed section and an outfeed section, where infeed and outfeed are relative to the gap between the two sections and where the infeed and/or outfeed section can be moved relative to the gap. In connection with the gap, a knife may be located and during a cutting process for cutting/portioning food items, a cut off piece can be directed through the gap or an end piece of a food item can be directed through the gap. Such a structure with or without a process being performed at the gap may allow rejection of food items or pieces thereof in a location between the start position and an end position. In case of processing of fish, the food item may be a whole fish or a fish fillet, and the pieces thereof may include a tail part or a head part which is typically rejected between the start position and the end position.

In a third aspect, the disclosure provides a computer program comprising instructions which, when the program is executed by a computer, cause the computer to carry out the method according to any of claims 1-9.

### BRIEF DESCRIPTION OF THE DRAWINGS

In the following, embodiments of the disclosure will now be described in further details with reference to the drawings, in which:

FIG. 1 illustrates two food items;

FIG. 2 schematically illustrates main components of a system according to the disclosure;

FIG. 3 illustrates further details of a system according to the disclosure;

FIG. 4 illustrates capturing an image of a food item,

FIG. 5 illustrates an overlap between an image of a food item and a 3D profile of the food item, and

FIG. 6 illustrates an outer contour determined based on the image and used for defining the volume of the food item.

### DETAILED DESCRIPTION OF THE DRAWINGS

The detailed description and specific examples, while indicating embodiments of the disclosure, are given by way of illustration only, since various changes and modifications within the spirit and scope of this disclosure will become apparent to those skilled in the art from this detailed description.

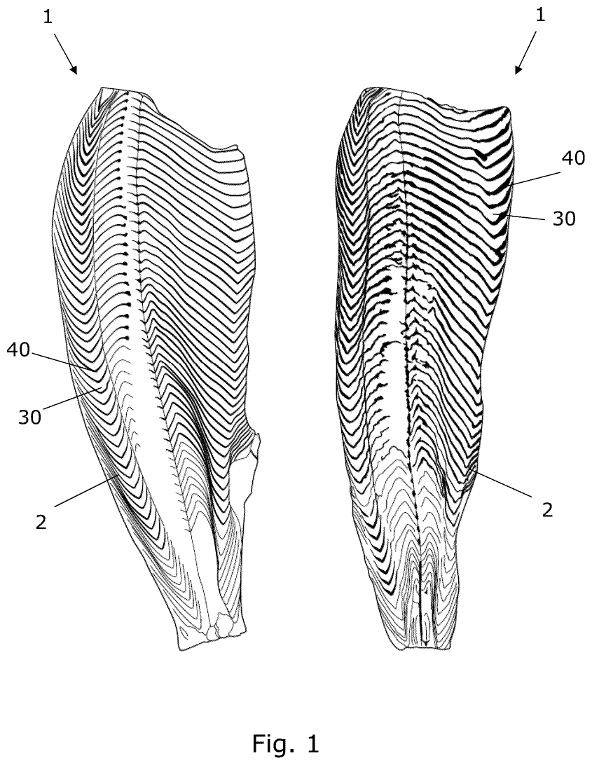

FIG. 1 is an image in the form of a digital colour image converted to grey tones. Each grey tone defines a measure by its “level of gray”.

In FIG. 1, the image shows two food items 1, each in the form of a fish fillet 2. The fish fillet 2 comprise a first tissue 30 in the form of meat and a second tissue 40 in the form of fat. In FIG. 1 meat 30 is illustrated as the white parts, whereas fat 40 is illustrated as the black parts. This is for illustration only, as the image 1 in one embodiment may be a colour image where the meat is red, and the fat is white. Based on the image 1, a content of each of the tissues is determined. This is referred to as a surface content since it is the content seen on the surface by the camera which takes the image.

The measure, i.e. in this case the grey scale, defines what is considered as fat and what is considered as meat, and the two different tissues can be distinguished from each other by introducing a threshold grey value. Pixels above the threshold represent meat, and pixels below the threshold represent fat.

In this case the first tissue is represented by meat 30, and the second tissue, in this case is represented by fat 40.

In the illustrated embodiment, larger white areas are observed in the fish fillets 2 illustrating that the main part hereof is meat 30.

When comparing the two food items 1, it can be seen that the areas of the second tissue 40; i.e. fat, of the two fish fillets 2 are different. The fish fillet 2 at the right side has broader stripes of fat 40 than the fish fillet 2 to the left. This indicates a higher amount of the second tissue 40, i.e. of fat, in the fish fillet at the right side and thereby a lower density for the fish fillet at the right side than the left side fish fillet 2.

As the fish fillet 2 to the right has a larger area of fat 40 than the fish fillet 2 to the left, the image for each fish fillet can identify by the measure of the pixels, a surface content of a first tissue which is distinct from a second tissue. The surface content in this example is a specific separation of pixels relating to fat from other pixels relating to meat. It could also have been an absolute surface area of the fat in the image, or it could have been a ratio of the area of the fat relative an area of meat in the image etc. This is referred to herein as image ratio.

As the amount of the first tissue 30 and/or the amount of the second tissue 40 may vary within the food item 1, the image ratio is not necessarily equal to the ratio between the first tissue 30 and the second tissue 40 in the food item as such.

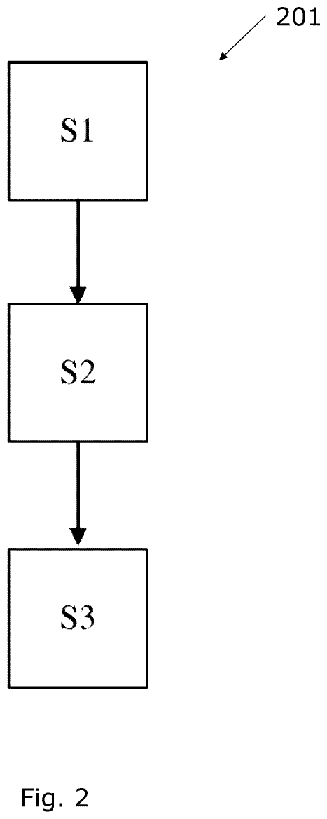

FIG. 2 schematically illustrates main components of a system 201 for estimating the weight of a food item 1. The system 100 comprises three stations, named S1, S2 and S3. The three stations could be connected e.g. by a conveyor or they could simply be three stations arranged at three different locations of a table or of a line comprising one or more conveyor belts. S1 could represent a start position e.g. a scanner for scanning food items. S2 could represent a handling station, e.g. a processing station where the weight of the food item 1 is estimated. Other handling steps could be sorting, counting, marking, fileting, trimming, control weighing, batching or any similar kind of known handling of food items. S3 could represent an end position e.g. a packing station.

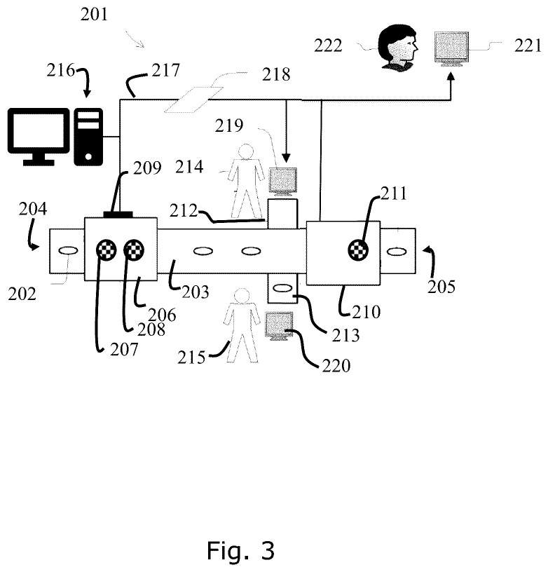

FIG. 3 illustrates further details of the system 201 schematically illustrated in FIG. 2. The exemplified system is configured for operator assisted processing of food items 202 but it could be fully automatic processing.

The illustrated facility comprises a conveyor 203, such as a conveyor belt which transports food items 202 from the intake 204 to the outlet 205.

At the weight estimation position 206, an image capturing device 207 is located such that it can provide images of the food items. In the illustrated embodiment, the image capturing device is located above the conveyor 203 and lamps 208 may be arranged to provide enough light for recognizing even fine details in the food items. The image capturing device 207 is based on visual light reflection, but in alternative embodiments, the image capturing device could be X-ray based or ultrasound based etc.

The system comprises a 3D image providing device 209 located at the weight estimation position and configured to provide a 3D image. The 3D image is used as a basis for determining food volume data representing a volume of the food item 202.

The 3D image providing device 209 may replace the image capturing device 207 if it can capture a pixel image with a measure for each pixel.

A weighing station 210 is arranged after the weight estimation where it is possible to weigh some of the food items. The actual weight can subsequently be used to calibrate the method of estimating the weight of the food items. A lamp 211 is positioned at the weighing station 210 for additional manual, visual scanning of the food item.

Between the intake 204 and the outlet 205, the food items are handled at a handling station. In this case, the handling station comprises two processing tables 212, 213. Alternatively, such handling stations may comprise automatic processing equipment.

An operator 214, 215 may be assigned to each processing table.

The computer 216 comprises a data input configured to receive from the image capturing device 207, the image of the food item, which image includes a plurality of pixels, e.g. arranged in a matrix of pixels, and each having a measure in the form of a grayscale value.

Distinct tissues of the food item are visual in the image.

The computer is further configured to receive from the 3D image providing device 209, the food item volume data representing a volume of the food item, e.g. via a Local area network, LAN 217. A CPU with corresponding software code is configured to form a processing structure and configured to determine from the image, a surface content of the first tissue distinct from the second tissue. This surface content could be expressed in said image ratio between a first tissue and a second tissue in the image.

The computer has a library of different transfer functions each configured to translate the surface content into a volume content. Each transfer function matches a specific situation, e.g. a specific type of food item, a season of the year, or other variables. The most promising transfer function for a specifically encountered situation is selected in a user interface, or automatically recognised by the computer. The computer may automatically shift between different transfer functions depending on the date and thus the time of the year, and the operator may select a new range of transfer functions when shifting from one species of fish to another species of fish.

A transfer function may, as an example be:

F(x)=k*x

where x is the surface content of a tissue (e.g. fat), F(x) is the volume content of that tissue, and k is a constant.

In another example, the transfer function may be:

F(x)=(i1*l1)+k*x

where i1 is empirical value representing an impact of a lengthwise dimension of the food item, l1 is the lengthwise direction, e.g. determined from the image, and where x is the surface content of a tissue (e.g. fat), F(x) is the volume content of that tissue, and k is a constant.

In an alternative implementation, the computer is programmed to apply a volume parameter to each pixel or region individually. In this implementation, the computer program determines a thickness related to the pixel or group of pixels. This thickness can be determined e.g. from a 3D image or other scanners known in the art. Subsequently, the computer determines a volume of the tissue which is represented by the pixel or group of pixels. In this case, the transfer function may e.g. have the form:

$$F ( a , h ) = {\sum }_{i = 1}^{n} ( ai * hi )$$

where ai is the area of pixel number i, or the area of a group, i, of pixels, and hi is the height of the food item at a pixel identified as pixel number i, or the height of the food item at the group, i, of pixels. F is the volume content of that tissue.

In another implementation, the computer is programmed with the following transfer functions

$$F 1 ( p ) = {\sum }_{i = 0}^{n} ( g ( pi ) * ( f 1 ( pi ) + ( 1 - f 2 ( pi ) ) ) \\ F 2 ( p ) = {\sum }_{i = 0}^{n} ( g ( pi ) * ( f 2 ( pi ) + ( 1 - f 1 ( pi ) ) ) )$$

Where p is all pixels, total number of pixels is n in the image. The function F1 returns the total volume of tissue 1 (e.g. fat), F2 returns the total volume of tissue 2 (e.g. meat). The function g returns the volume for this pixel group (calculated as surface area*height). The function F1 returns a number in the interval [0,1] representing the amount of tissue 1 (e.g. fat) for this pixel. The function F2 returns the amount of tissue 2 (e.g. meat) for this pixel.

The functions F1 and F2 will take surface tissue in this pixel group into consideration, and f1 could return 1.0 if the entire pixel group is tissue 1 at the surface, but it could also know based on product-age/spices/etc. or location on the food item that e.g. only 0.7 is fat.

The computer can record a density parameter of the food item, the density parameter comprising at least a first density contribution related to the first tissue and a second density contribution related to the second tissue. The density parameter can be received by LAN from another computer system, or it could be manually entered by an operator of the system.

Based on the volume content, the density parameter, and the food item volume data, the computer can estimate a weight of the food item.

An example of a C++ object for executing the method is provided below. In this example, the first tissue is fat and the second tissue is meat. The example is

```
enum TisueType { FAT, MEAT };
struct Pixel
{
  double height;
  double area;
  TisueType tissue_type;
  list<double> location;
};
double calcFatShare(Pixel p) { return 0.8; }
double calcFatMeat(Pixel p){ return 0.98; }
list<double> calcTisueVolumens(list<pixel> pixels)
{
  double volumen_fat = 0;
  double volumen_meat = 0;
  for(int i=0; i<pixels.size( ); ++i)
  {
  Pixel p = pixels[i];
  double pixel_volumen = p.height * p.area;
  if(p.tissue_type==FAT)
  {
    double k1 = calcFatShare(p);
    volumen_fat = volumen_fat + pixel_volumen * k1;
    volumen_meat = volumen_meat + pixel_volumen * (1−k1);
  }
  else if(p.tissue_type==MEAT)
  {
    double k2 = calcMeatShare(p);
    volumen_meat = volumen_meat + pixel_volumen * k2;
    volumen_fat = volumen_fat + pixel_volumen * (1−k2);
  }
  }
  return {volumen_fat, volumen_meat};
}
```

The functions calcFatShare and calcFatMeat could take p.height or p.location into consideration. It could also use age of the food item. In a more advanced formula, also neighbouring pixels could be taken into consideration. E.g. If all surrounding pixels in 4 mm radius is fat, the calcFatShare( ) could return 1.0, but if only 20% of the pixels is that radius is fat, then return 0.15.

The computer 216 may generate a data file 218, symbolized by the product card 218. The data file may contain the estimate weight of the food item 202 and/or non-cut sections hereof and other kinds of data related to the food item or to the handling of the food item.

Each processing table 212, 213 may have computer interfaces, e.g. in the form of touch screens 219, 220 enabling the operator to identify the food item, to generate information related to the food item. Such information may specify an ID of the operator, an ID of the table, or visually observed issues related to the food item, e.g. quality parameters observed by the operator. The information can be transmitted by the LAN 217 to the computer 216 or elsewhere, e.g. to the supervisor computer system 221 where a supervisor 222 may review the data. The data could be included in the data file 218, e.g. together with the estimated weight. Data, e.g. as included in the data file, could also be exported e.g. to adjacent handling stations, or to follow the food item or pieces thereof all the way to the consumer.

The outlet 205 could be arranged to deliver the food items to adjacent handling stations, e.g. for further processing, packing, inspection, or rejection etc.

The illustrated system comprises a weighing station 210 for controlling the estimated weight of the food items. The system may form part of a grader capable of grouping a number of food items depending on a characteristic, e.g. in order to obtain batches of a specific weight or number of food items. A weighing station could generally be placed anywhere downstream relative to the image capturing device 207. Particularly, the weighing station may be arranged to weigh the batches, i.e. an accumulation of a number of food items for which the weight is estimated individually. In this case the weight could be stored relative to a number of previously prepared batches, e.g. a weight of the last 1000 batches of food items being prepared in the system. The number of previously prepared batches may define a moving window as explained below.

The system may also store the volume of one of the tissues, e.g. the content of fat, and/or the content of meat for each fish in the box.

Every time a weight of a new batch is saved, the computer may be configured to check, by use of the scale if the weight is reasonable, e.g. within a few percent of the expected weight, i.e. the weight constituted by the sum of the estimated weights of the food items in that batch.

If the difference between the estimated weight and the measured weight is within certain tolerances, the oldest box is deleted from the memory.

The number of batches is dived in to two groups (could be even and odd batch numbers prepared by the system).

For the two groups two equations with two unknowns are found:

V1f*Df+V1m*Dm=W1

V2f*Df+V2m*Dm=W2

Wherein V1f is volume for fat of the food item no 1, D is density of the food item, Df is density for fat, and Dm is density for meat. W is weight of the food item. The reference sign 1 or 2 illustrates that the equation is for food item no. 1 and 2.

The equations are solved, and two new density-fat and density-meat are found.

The new density could be used directly, or it could be applied to the existing with a learning_rate e.g. L=0.1

Dup_dated=Dold*(1−L)+Dnew*L

The above example could be a moving window with a larger number of batches, e.g. 1000 batches. A smaller moving window could also be used thereby providing a lower learning rate e.g. 0.001 and only use the last two batches instead of a large number of batches, e.g. instead of 1000 batches.

Alternatively, an algorithm could be defined where more outliers are filtered out. E.g. use the lase 2*10 batches, the 2 batches with most positive divination and the two batches with most negative divination are not used. The remaining 16 batches are divided into two groups and the two equations with two unknowns are created and solved.

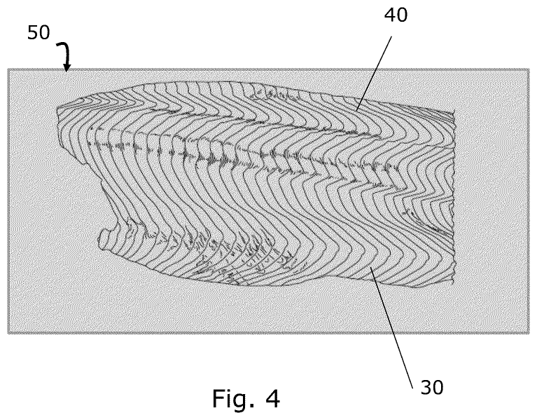

FIG. 4 illustrates capturing of an image 50 of a food item 1 in the form of a fish fillet 2. The image 50 shows a first tissue 30 in the form of meat and a second tissue 40 in the form of fat.

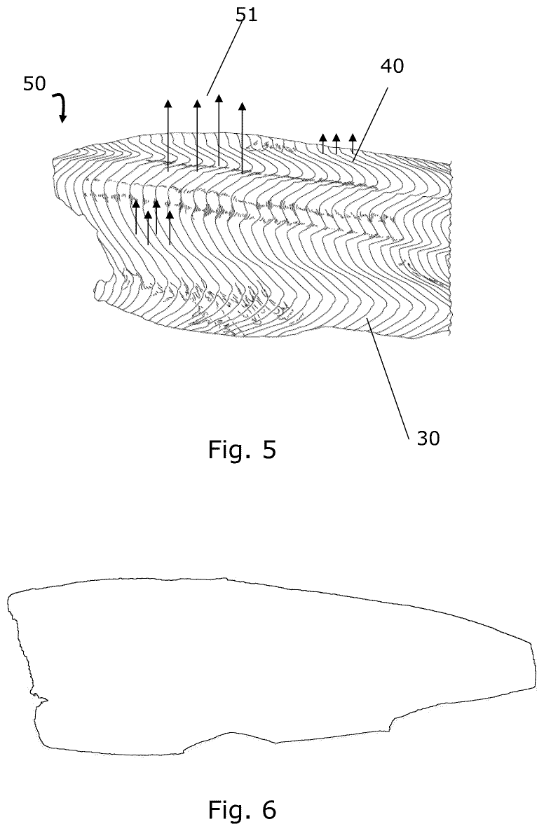

FIG. 5 illustrates an image 50 with an overlay of a 3D profile in the form of vectors 51 each defining height of the food item at a particular pixel or at a group of pixels. Only a reduced number of vectors 51 are shown. In practise, the 3D profile contains a vector for each pixel or group of pixels, and the length of each vector indicates the height. This combination between the 3D profile and the image allows the computer program to determine a thickness related to the pixel or group of pixels. The computer may use the information to determine a volume content contribution of e.g. fat from a particular pixel or group of pixels.

Subsequently, the computer may accumulate the volume content contributions from each pixel or group of pixels and thereby define the volume content. The accumulation may e.g. be carried out by the below illustrated function:

$$Vc ( vcc ) = {\sum }_{i = 1}^{n} vcci$$

where vcci is the volume content contribution from pixel no i or from group i of pixels and Vc is the volume content.

FIG. 6 illustrates an outer contour of another food item. The outer contour can be determined by the measure of the pixel. The computer uses the contour to determine the volume of the food item. The surface on which the food item is arranged may have a colour which is distinct from the colour of the food item. This may increase the ability to precisely define the outer contour and thereby provide a better basis for determining the volume data.

1.-21. (canceled)

22. A method of determining a weight estimate of food items, the method comprising the steps of:
a) receiving an image of an outer surface of a food item, the image comprising a plurality of pixels each having a measure;
b) identifying by the measure of the pixels, a surface content of a first tissue which is distinct from a second tissue;
c) translating the surface content into a volume content;
d) recording a density parameter of the food item, the density parameter comprising at least a first density contribution related to the first tissue and a second density contribution related to the second tissue;
e) receiving food item volume data representing a volume of the food item or a section thereof; and
f) determining based on the volume content, the density parameter, and the food item volume data, a weight estimate of the food item or a section thereof.

23. The method according to claim 22, wherein the translation of the surface content into the volume content is carried out by linking each pixel or a group of pixels to a height of the food item at the pixel or group of pixels and converting, based on the height, the identified surface content into a volume content contribution.

24. The method according to claim 23, wherein the volume content is based on an accumulation of the volume content contribution from each pixel or group of pixels.

25. The method according to claim 23, comprising extracting from a 3D profile of the food item, the height of the food item at each pixel or group of pixels in the image.

26. The method according to claim 22, comprising extracting from a 3D profile of the food item, the food item volume data.

27. The method according to claim 22, wherein step c) of translating the surface content into a volume content is carried out by use of a transfer function depending on empirical data.

28. The method according to claim 22, comprising:
providing a first transfer function and a second transfer function, both configured for translating the surface content into a volume content; and
selecting between using the first transfer function and the second transfer function for carrying out step c) depending on empirical data.

29. The method according to claim 22, further comprising determining an actual weight by weighing the food item and amending at least one of the translations in step c, and the density parameter recorded in step d) depending on a deviation between the weight estimate found in step f) and the actual weight found by weighing the food item.

30. The method according to claim 22, further comprising a step of sectionalizing the food item into a plurality of sections, and a step of determining a sectional weight estimate of the food item sections based on the volume content, the density parameter, and the food item volume data.

31. The method according to claim 30, further comprising cutting the food items into food portions in accordance with the sectionalizing.

32. The method according to claim 22, wherein said food item is a fillet of a Salmonidae, such as Salmo salar.

33. A system for processing a food item, the system comprising:
at least one conveyor configured to move the food item in a flow of food items from a start position to at least one processing position;
an image capturing device configured to provide an image of the food item, the image comprising a plurality of pixels each having a measure;
a processing structure configured to:
identify by the measure of the pixels, a surface content of a first tissue which is distinct from a second tissue;
translate the surface content into a volume content;
record a density parameter of the food item, the density parameter comprising at least a first density contribution related to the first tissue and a second density contribution related to the second tissue;
receive food item volume data representing a volume of the food item; and
determine based on the volume content, the density parameter, and the food item volume data, a weight estimate of the food item.

34. The system according to claim 33, comprising a 3D image providing device configured to provide a 3D profile of the food item, and
wherein the processing structure is configured to extract from the 3D profile, the food item volume data and/or a height of the food item.

35. The system according to claim 34, wherein the 3D image providing device is constituted by the image capturing device.

36. The system according to claim 33, forming part of a batching or grading device comprising multiple receiving bins and a controller configured for assigning food items to the bins based on a batching or grading criteria comprising the weight of the food item,
wherein the controller is configured to use the weight estimate determined based on the volume content, the density parameter, and the food item volume data for the assigning of the food items into the bins.

37. The system according to claim 36, wherein the controller is configured to receive from a scale, a compiled weight of a plurality of food item contained in one of the bins, and to compare the compiled weight with summation of the estimated weight of each of the items in the bin.

38. The system according to claim 37, wherein the controller is configured to receive from a scale, a plurality of compiled weights of food item contained in a plurality of the bins, and to compare the compiled weight with summation of the estimated weight of each of the items in the bin.

39. The system according to claim 37, where the translation and/or the density parameter is amended based on a deviation between the compiled weight and the summation of the estimated weights.

40. The system according to claim 33, forming part of a food portioning system,
wherein the processing structure is configured to sectionalize the food item into a plurality of sections, and to determine a sectional weight estimate of the food item sections based on the volume content, the density parameter, and the food item volume data.

41. The system according to claim 40, further comprising a cutting structure configured to cut the food items into food portions based on the sectionalizing.

42. A computer program comprising instructions which, when the program is executed by a computer, cause the computer to carry out the method according to claim 22.
